(19) United States
(12) Patent Application Publication
(10) Pub. No.: US 2015/0373658 A1
(43) Pub. Date: Dec. 24, 2015

(54) Method for Deferring Beacon and Communication Device thereof

(71) Applicant: MEDIATEK INC., Hsin-Chu (TW)

(72) Inventors: Ching-Hwa Yu, Tainan City (TW); Hao-Hua Kang, Taoyuan City (TW)

(21) Appl. No.: 14/742,715

(22) Filed: Jun. 18, 2015

Related U.S. Application Data
(60) Provisional application No. 62/014,126, filed on Jun. 19, 2014.

(51) Int. Cl. H04W 56/00; H04W 52/02; H04W 72/04; H04J 3/06; H04J 3/16

(52) U.S. Cl. CPC H04W 56/0015; H04J 3/0658; H04J 3/1694; H04W 72/0446; H04W 52/0216

(57) ABSTRACT

A method, for a communication device in a wireless communication system, includes receiving a plurality of frames for synchronization at a plurality of target times; and transmitting a packet for deferring a next target time to receive a next frame when the next frame is determined not to be received at the next target time.

### CROSS REFERENCE TO RELATED APPLICATIONS

This application claims the benefit of U.S. Provisional Application No. 62/014,126 filed on Jun. 19, 2014 the contents of which are incorporated herein in their entirety.

### BACKGROUND

The present invention relates to a method for a wireless communication system and communication device thereof, and more particularly, to a method for deferring frames for synchronizations and communication device thereof.

Wireless communication has become an important and essential data transmission technique in recent years since it takes several advantages such as high transmission flexibility, high transmission convenience, and high transmission quality. Nowadays, several wireless communications modules for transmitting various radio signals are integrated into a portable electronic device. For example, a blue-tooth (BT) module, a Wi-Fi module, and a long-term-evolution (LTE) module may be integrated in an electronic device such as a smartphone. To improve the transmission efficiency, two transmission types are applied to achieve the coexistence of multi-radios transmission. The first transmission type is frequency division multiplexing (FDM) and the second transmission type is time division multiplexing (TDM). The key idea of the transmission using FDM is to partition a wireless frequency spectrum into several frequency bands and further allocate each radio signal to the corresponding frequency band. On the other hand, the key idea of the transmission using TDM is to determine several time slots during a transmission time interval and allocate each radio signal to the corresponding time slot. Both FDM and TDM can provide multi-radio coexistence transmission.

In a wireless communication system, a network (e.g. an access point (AP)) periodically transmits a Beacon frame for synchronizing with communication devices (e.g. stations or smart phones) connected to the network. However, if a communication device does not stay in the wireless communication system (e.g. the communication device switches to another wireless communication system) when the network transmits the Beacon frame, the communication device would lose reception of the Beacon frame and the communication device is required to wake up to receive the subsequent Beacon frames, resulting that the power consumption of the communication device increases. Further, once the communication device misses a Beacon frame, the communication device is most likely to miss subsequent Beacon frames in a row and the connection between the communication device and the network may be lost. Thus, how to guarantee that the communication device receives the Beacon frame for the synchronization becomes a topic to be discussed.

### SUMMARY

In order to solve the above problems, the present invention provides a method of deferring frames for synchronizations.

The present invention discloses a method for a communication device in a wireless communication system. The method comprises receiving a plurality of frames at a plurality of target times; and transmitting a packet for deferring a next target time to receive a next frame when the next frame is determined not to be received at the next target time.

The present invention further discloses a communication device in a wireless communication system. The communication device comprises a computing unit; and a storage unit, for storing a program code used for instructing the computing unit to perform the following steps: receiving a plurality of frames at a plurality of target times; and transmitting a packet for deferring a next target time to receive a next frame when the next frame is determined not to be received at the next target time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a timing diagram according to an example of the present invention.

### DETAILED DESCRIPTION

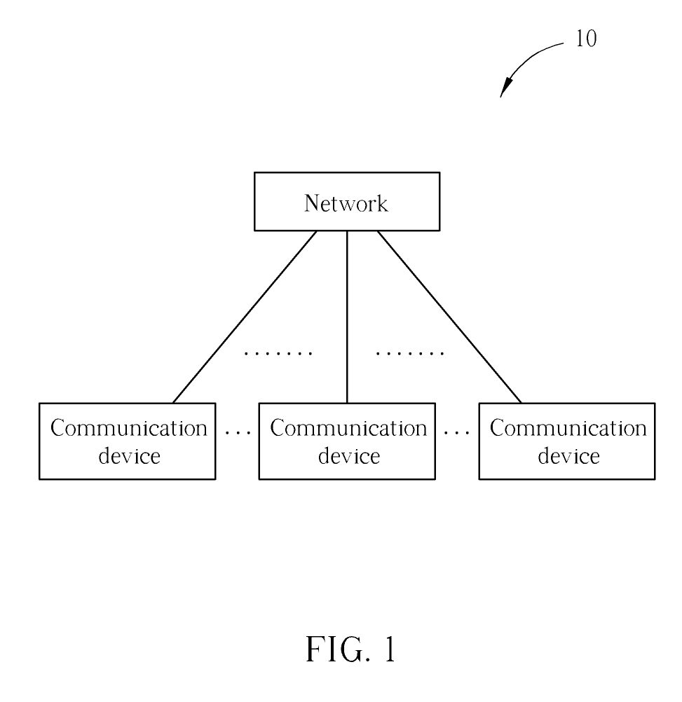

Please refer to FIG. 1, which is a schematic diagram of a wireless communication system 10 according to an example of the present disclosure. The wireless communication system 10 is briefly composed of a network and a plurality of communication devices. In FIG. 1, the network and the communication devices are simply utilized for illustrating the structure of the wireless communication system 10. Practically, the network maybe a small cell network, a universal terrestrial radio access network (UTRAN) comprising a plurality of Node-Bs (NBs) in a universal mobile telecommunications system (UMTS). In another example, the network may be an evolved UTRAN (E-UTRAN) comprising a plurality of evolved NBs (eNBs) and/or relays in a long term evolution (LTE) system, a LTE-Advanced (LTE-A) system or an evolution of the LTE-A system. In still another example, the network may be an access point (AP) of a WiFi system.

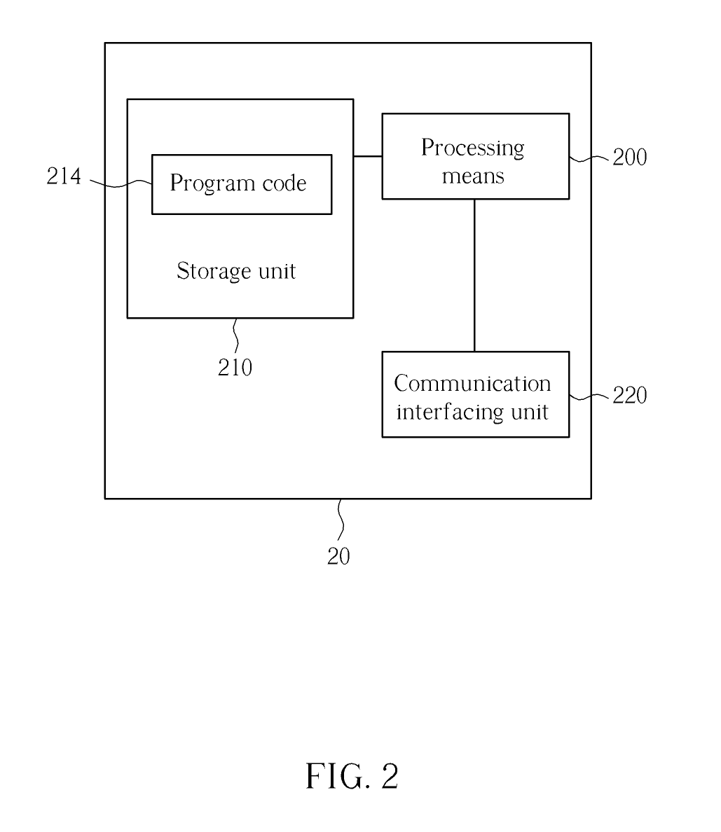

Please refer to FIG. 2, which is a schematic diagram of a communication device 20 according to an example of the present disclosure. The communication device 20 may be a communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that stores a program code 214, accessed and executed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals (e.g., messages or frames) according to processing results of the processing means 200.

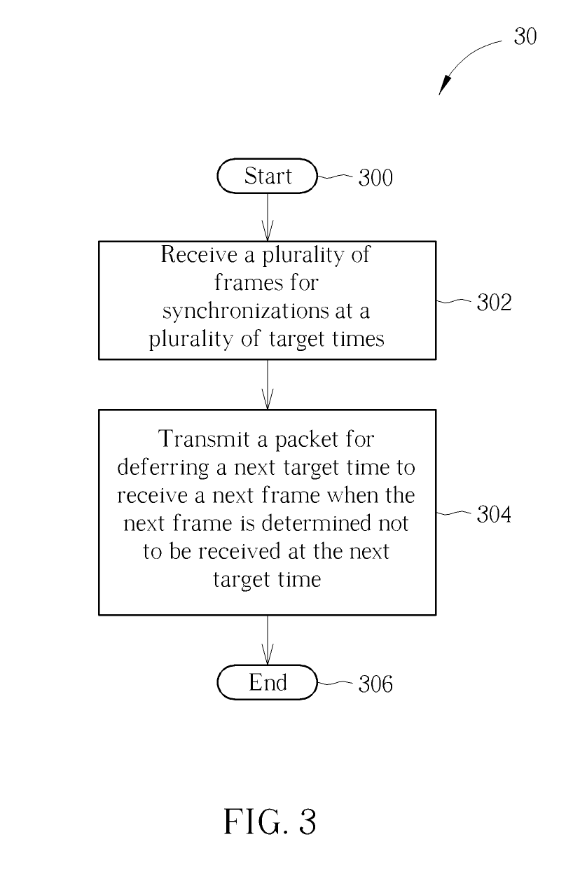

Please refer to FIG. 3, which is a flowchart of a process 30 according to an example of the present invention. The process 30 is utilized in the communication device shown in FIG. 1 for ensuring that the communication device receives the frames for synchronizations (e.g. the Beacon frames) . The process 30 can be compiled into the program code 214 and comprises the following steps:

Step 300: Start.

Step 302: Receive a plurality of frames for synchronizations at a plurality of target times.

Step 304: Transmit a packet for deferring a next target time to receive a next frame when the next frame is determined not to be received at the next target time.

Step 306: End.

According to the process 30, the communication device periodically receives a plurality of frames for the synchronizations at the plurality of target times (e.g. the Time to Beacon Target Times (TBTTs)) from the network. After periodically receiving the frames, the communication device expects to receive a next frame for synchronization at a next target time and determines whether the next frame will be successfully received at the next target time. For example, the communication device may stay in another wireless communication system (e.g. BT or LTE communication system) instead of the wireless communication system 10 at a next target time. In such a condition, the communication device determines that the next frame from the network will not to be received at the next target time. In another example, the communication device may perform operations which affect the reception ability of the communication device at the next target time and cause the communication device losing the next frame at the next target time. For example, the communication device may be a network card and may transmit data via a Universal Serial Bus 3.0 (USB3.0) interface module at the next target time. Since the communications between the network and the communication device may be affected by the USB3.0 interface module, the reception of the next frame may fail. In such a condition, the communication device also determines that the next frame will not to be successfully received at the next target time.

When the communication device determines that the next frame will not to be received at a next target time, the communication device transmits a packet before the next target time for deferring the next target time. The packet comprises an indicator for indicating a deferring time, wherein the communication device may return to the network of the wireless communication system 10 after the deferring time. According to the packet, the network defers the next target time of transmitting the next frame by the deferring time and transmits the frame at the deferred next target time. Via the process 30, the communication device would not lose any of the frames for synchronizations and the connection between the communication device and the network would not be lost. In addition, the power consumption of the communication device is also decreased.

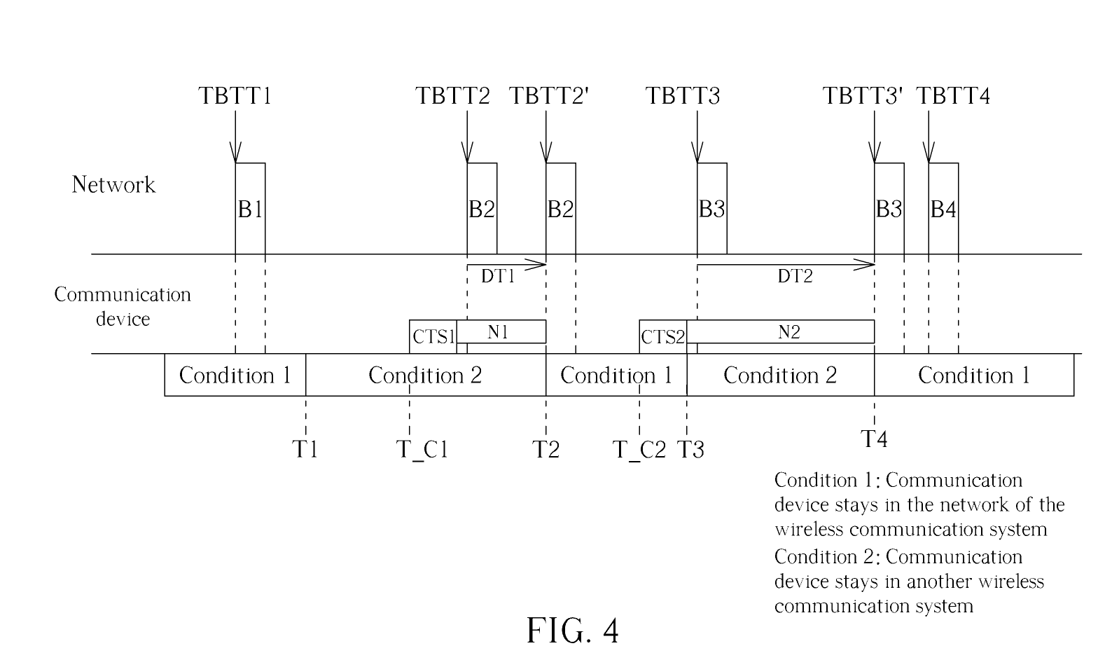

In an example, the packet may be a Clear to Send to Self (CTS2Self) packet for triggering a Network Allocation Vector (NAV). That is, the communication device defers the next target time via the NAV. Please refer to FIG. 4, which is a timing diagram according to an example of the present invention. As shown in FIG. 4, the network plans to transit Beacon frames B1-B4 (i.e. the frames for synchronizations) at the times TBTT1-TBTT4 (i.e. the target times). At the time TBTT1, the communication device stays in the network of the wireless communication system 10 and receives the Beacon frame B1 successfully. Next, the communication device switches to another wireless communication system from a time T1 to a time T2, resulting that the communication device cannot receive the Beacon frame B2 at the time TBTT2. In such a condition, the communication device transmits a CTS2self packet CTS1 (i.e. the packet of step 304) for triggering a NAV N1 at a time T_C1 before the time TBTT2. According to the NAV N1, the network acknowledges that the medium of the wireless communication system 10 is occupied till the time T2. Note that, the effects on the operations (e.g. transmissions) of the communication device due to the transmission of the CTS2self packet CTS1 can be ignored since the size of the CTS2self packet CTS1 is sufficiently small and transmitting the CTS2self packet CTS1 only takes extremely short time. Before transmitting the Beacon frame B2 at the time TBTT2, the network receives the CTS2self packet CTS1 and defers the time TBTT2 by the deferring time DT1 according to the NAV N1. That is, the time TBTT2 is deferred to the time TBTT2′ (i.e. the time T2). The communication device can therefore receive the Beacon frame B2 after returning to the network of the wireless communication system 10 at the time T2 and perform the synchronization with the network.

Similarly, during the period of the communication device staying in the network of the wireless communication system 10 from the time T2 to a time T3, the communication device determines that the time TBTT3 of receiving the Beacon frame B3 does not align the period of staying in the wireless communication system 10. The communication device therefore transmits a CTS2self packet CTS2 for triggering a NAV N2 at a time T_C2 before the time T3, to defer the time TBTT3 to the time TBTT3′ (i.e. the time T4). As a result, the communication device receives all of the Beacon frames B1-B4 and accordingly synchronizes with the network of the wireless communication system 10. The connection between the network and the communication device is maintained and the power consumption of the communication device is decreased, therefore.

Note that, the packet for deferring the next target time of receiving the next frame for synchronization (e.g. the CTS2self packets CTS1 and CTS2) may be transmitted when the communication device stays in the wireless communication system 10 (e.g. the CTS2self packet CTS2) in an example. In another example, the packet for deferring the next target time of receiving the next frame for synchronization may be transmitted when the communication device does not stay in the communication system 10 (e.g. the CTS2self packet CTS2). For example, the communication device may stay in the BT communication system rather than the communication system 10 (e.g. WIFI communication system) at the next target time of the next frame for synchronization. When deciding to transmit the packet of deferring the next target time, the communication device switches to the communication system 10 during the gaps of transmitting packets in the BT communication system, to transmit to the packet of deferring the next target time. After the packet of deferring the next target time is transmitted, the communication device switches back to the BT communication system.

According to different applications and design concepts, those with ordinary skill in the art may observe appropriate alternations and modifications. In an example, the packet of deferring the next target time may be a null packet comprising a physical layer convergence procedure (PLCP) length field for indicating the deferring time. In other words, the communication device defers the next target time via the PLCP. In this example, the wireless communication system 10 may be a mixed mode wireless communication system (e.g. an 802.11b/g/n mixed mode wireless local area network (WLAN)) and the null packet may be a Complementary Code Keying (CCK) Quality of Service (QoS) null packet which does not comprise acknowledgment (ACK) and comprises the PCLP length field for indicating the deferring time.

Those skilled in the art should readily make combinations, modifications and/or alterations on the abovementioned description and examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the above example defers the target times of the network transmitting the frames for the synchronizations when the communication device determines the receptions of the frames for the synchronizations would fail. As a result, the communication device would not lose any of the frames for the synchronizations, the connection between the communication device and the network would not be lost, and the power consumption of the communication device is decreased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a communication device in a wireless communication system, the method comprising:
receiving a plurality of frames at a plurality of target times; and
transmitting a packet for deferring a next target time to receive a next frame when the next frame is determined not to be received at the next target time.

2. The method of claim 1, wherein the each of the plurality of frames and the next frame are used for synchronizations.

3. The method of claim 2, wherein each of the plurality of frames and the next frame are Beacon frames.

4. The method of claim 1, wherein the packet is a Clear to Send to self (CTS2Self) packet for triggering a Net Allocation Vector comprising timing information of deferring the frame.

5. The method of claim 1, wherein the packet comprises a physical layer convergence procedure (PLCP) length filed.

6. A communication device in a wireless communication system, the communication device comprising:
a computing unit; and
a storage unit, for storing a program code used for instructing the computing unit to perform the following steps:
receiving a plurality of frames at a plurality of target times; and
transmitting a packet for deferring a next target time to receive a next frame when the next frame is determined not to be received at the next target time.

7. The communication device of claim 6, wherein each of the plurality of frames and the next frame are used for synchronizations.

8. The communication device of claim 7, wherein each of the plurality of frames and the next frame are Beacon frames.

9. The communication device of claim 6, wherein the packet is a Clear to Send to self (CTS2Self) packet for triggering a Net Allocation Vector comprising timing information of deferring the frame.

10. The communication device of claim 6, wherein the packet comprises a physical layer convergence procedure (PLCP) length filed.
